(19) United States
(12) Patent Application Publication
(10) Pub. No.: US 2019/0006697 A1
(43) Pub. Date: Jan. 3, 2019

(54) METHOD FOR PRODUCING A BATTERY CELL

(71) Applicant: Robert Bosch GmbH, Stuttgart (DE)

(72) Inventors: Stephan DANKO, Stuttgart (DE); Olivier SCHECKER, Karlsruhe (DE); Tjalf PIRK, Stuttgart (DE)

(21) Appl. No.: 16/065,395

(22) PCT Filed: Dec. 16, 2016
(86) PCT No.: PCT/EP2016/081528

§ 371 Date: Jun. 22, 2018

(30) Foreign Application Priority Data
Dec. 22, 2015 (DE) 10 2015 226 540.4

(51) Int. Cl. H01M 10/04; H01M 10/0525; H01M 2/02; H01M 4/38; H01M 4/04; H01M 4/139

(52) U.S. Cl. CPC H01M 10/049; H01M 10/0525; H01M 4/139; H01M 4/382; H01M 4/0426; H01M 2/0267

(57) ABSTRACT

The invention relates to a method for producing a battery cell (10), in particular a solid-state battery cell, wherein material particles (1) are provided with a first coating (3), wherein in a deposition step the material particles (1) having the first coating (3) are accelerated toward a substrate (112) in such a way that the first coating (3) of the material particles (1) joins with the first coating (3) of further material particles (1) upon hitting the substrate (112) such that a first layer (30) is formed, in particular without an input of heat from outside.

### BACKGROUND OF THE INVENTION

The present invention relates to a method for producing a battery cell, a battery cell, and a device for the production thereof.

A battery cell is an electrochemical storage device which, when discharged, converts the stored chemical energy by means of an electrochemical reaction into electrical energy. It is apparent that in the future, both in stationary applications such as wind power plants, in motor vehicles configured as hybrids or electrical vehicles, and in electronic devices, new battery systems will be used on which the strictest requirements will be placed with respect to reliability, safety, performance, and useful life. Because of their high energy density, lithium ion batteries in particular will be used as storage devices for electrically driven motor vehicles.

JP 2015-053236 discloses a method for producing an electrode body wherein active material particles are coated with a niobium oxide layer. In a further step, the coated active material particles are deposited on a substrate and heated.

US 2013/0252094 discloses a negative electrode with a conductor and an active material layer composed of silicon particles, wherein the silicon particles are partially coated with a coating.

Battery cells with a liquid electrolyte usually have porous compound electrodes so that the pores of said electrodes can be filled with the liquid electrolyte, which serves as an ionic conduction network and transports ions.

Moreover, solid-state or thin-layer batteries are known which comprise compact active material layers instead of porous compound electrodes.

In the following, an active material is to be understood as a storage material that is capable of reversibly incorporating lithium ions. The active material is applied, for example, to a conductor of an electrode of a battery cell and forms the electrode together with the conductor.

### SUMMARY OF THE INVENTION

According to the invention, a method is provided for producing a battery cell, in particular a solid-state battery cell, wherein material particles are provided with a first coating, as well as a battery cell and a device for the production thereof.

This is based in particular on the fact that in a deposition step, the material particles having the first coating are accelerated toward a substrate such that the first coating of the material particles bonds with the first coating of further material particles on impacting the substrate so that a layer is formed. This takes place in particular without an input of heat from outside. In particular, the material particles are accelerated toward the substrate at a speed sufficient to cause the coatings of the material particles to react with one another. An advantage of the method according to the invention, for example, is that compared to pressing processes, layers with higher densities are obtained, and better adhesion of the material particles with an applied coating to one another is also achieved. It is further advantageous that uniform distribution and crosslinking of the coated materials is achieved without the occurrence of local material concentrations. For example, this aspect is particularly advantageous in the production of electrodes for battery cells. Electrodes of battery cells comprise for example an active material and a conducting material. Here, a conducting material is understood to be an ion-conducting material, in particular a lithium-ion-conducting material. By means of the particularly uniformly distributed coated material particles obtained according to the method of the invention, it is possible to use a smaller proportion of conducting material and a larger proportion of active material without affecting the performance of the battery. The advantage in this case is that this significantly increases the capacity of the battery cell while maintaining unchanged performance.

It is further advantageous that by means of the method according to the invention, for example compared to methods for the production of battery cells with a liquid electrolyte, highly compact and stable layers are obtained. This makes it possible, for example, to carry out more charging and discharging processes, and the useful life of the battery cell is also significantly increased, which in turn cuts costs and increases the sustainability of the battery cell. In addition, solid-state-based battery cells, for example, are safer because they are highly flame resistant, there is no liquid electrolyte present that can leak from the battery cell, and they are also highly stable with respect to temperature fluctuations.

It is further advantageous that the layer does not first have to be converted by thermal and/or mechanical processes into a solid layer, but is directly applied in the required composition. For example, this makes it possible to save time, steps, and costs, reduce sources of error and impurities, and increases the useful life of the layer.

A further advantage of the method according to the invention is that layers with the widest possible variety of properties can be produced. The properties of the material particles are combined with the properties of the coating that is applied to the material particles. In this manner, various desired properties can be combined in one layer. Examples of such properties of a layer of a battery cell include ion conductivity, electron conductivity, ion storage capacity, temperature resistance, elasticity, or a protective action.

It is also advantageous that the method according to the invention is highly flexible with respect to varying parameters such as the thickness of the layer, the density of the layer, or the lateral dimensions of the layer. For example, these parameters can be very quickly adjusted as desired.

It is further advantageous that by means of the method according to the invention, tests can be rapidly and easily carried out with respect to various compositions of the layer, i.e. the material particles and the coating, which is applied to the material particles.

Particularly preferably, the method is carried out without any thermal input from outside. This allows the use of more material classes, as it is thus also possible to use materials that are not stable, become inactive, or decompose under the effect of temperature. Moreover, the material particles or the coating show better aging properties when they are not subjected to prior thermal treatment.

Alternatively, the material particles and/or the coating are heated, for example, during the coating step. The advantage in this case is that in this manner, homogenous layers are obtained.

Further alternatively, the material particles and/or the coating are cooled, for example, during the coating step. This is advantageous for materials that react as a result of temperature with other materials such as atmospheric components, and such reactions in a cooled state can for example be prevented or significantly slowed.

In an embodiment, it is advantageous if at least one second coating is applied to the first coating of the material particles. The advantage in this case is that in this manner, highly complex composite layers with combined properties can be produced. In this case, the properties of the material particles are combinable with the properties of the first coating and with the properties of the second coating, as well as with further coatings if applicable. Examples of such properties include ion conductivity, electron conductivity, temperature resistance, elasticity, ion storage capability, or a protective action. In addition, a coating, for example the first or the second coating, can also comprise a mixture of different materials.

In an embodiment, the first coating of the material particles and/or the second coating breaks open on impact on the substrate and/or fuses with the first coating of further material particles and/or the second coating. The advantage in this case is that in this manner, particularly favorable and even distribution of the components is ensured, and local material concentrations are avoided. For example, it is also advantageous that no temperature effect is necessary for this purpose.

In a particularly preferred embodiment, the first coating and/or the second coating is configured to be ion-conducting. The advantage in this case is that because of the even distribution and crosslinking of the coated material particles achieved by means of the method according to the invention, ion-conducting paths are produced. This allows an extremely favorable ion-conducting network to be obtained, by means of which the stored ions, in particular lithium ions, can be more rapidly removed from storage, for example from the active material in which the are stored, thus increasing the performance of the battery.

In an additional or alternative embodiment, the first coating and/or the second coating is configured to be electron-conducting, which ensures more rapid and effective transportation of the electrons required for electrochemical incorporation into the active material, as well as more rapid and effective transportation away of the electrons released in the discharging process for use in the external load circuit.

In a preferred embodiment, the ion-conducting coating comprises a garnet, in particular LiₓLaZrO, a sulfidic or a phosphatic glass, in particular Li₁₀XP₂S₁₂, where X=Ge, Sn, and/or an argyrodite, in particular Li₆PS₅CI. This is advantageous in that the aforementioned materials show extremely high ionic conductivity, which for example is comparable with the conductivity of liquid ion conductors. Furthermore, it is advantageous that these materials are generally thermally stable and non-flammable and are also stable in environmental air.

In a further embodiment, it is advantageous if the first coating and/or the second coating is an active material. For example, if material particles composed of active material of a battery cell are coated with a coating comprising a further active material, the properties of the two active materials used can be combined with one another. Examples of this are material particles composed of lithium metal phosphates (LXP), nickel cobalt manganese (NCM) oxides, nickel cobalt manganese aluminum (NCA) oxides, or vanadium oxides which are coated with a coating composed of aluminum oxide (AI₂O₃), zirconium oxide (ZrO₂), LiloSnP₂S₁₂, LiTi₂(PO₄)₃, lithium niobate (LiNbO₃), lithium phosphate (Li₃PO₄), LiSn₂(PO₄)₃, or further oxides, phosphates or sulfidic glasses. Because of the aforementioned coatings, for example, the material particles are chemically and mechanically stabilized, and boundary resistance with respect to further materials, for example, is reduced.

In an alternative or additional embodiment, it is advantageous if the first coating and/or the second coating is a protective material. In this case, a protective material is understood to mean a material that protects the underlying component(s), in particular against harmful influences such as atmospheric components, moisture, or undesired temperature effects. In a coating composed of a protective material, it is advantageous that the underlying layers or layer stacks are thus protected. In particular, the coating composed of protective material protects the material particles even during the deposition step. A further advantage in this case is that the coating constituting a protective material allows the use of a plurality of materials, as one can even use materials that would not be usable without the protective material because they would otherwise undergo undesired reactions with atmospheric components or would decompose.

In a further embodiment, the material particles are active material particles of an electrode of the battery cell or conducting material particles of an electrode of the battery cell.

In a particularly preferred embodiment, the coating step, in which the material particles are provided with the coating and/or the further coating, and the deposition step are carried out in the same device. The advantage in this case is that it is not necessary to procure, operate, maintain, and clean two different coating devices. In addition, the materials do not have to be transported from one device to another. By using a single device in which both the coating step and the deposition step are carried out, both costs and work time are saved. Moreover, for example, this allows atmospheric exposure of the materials between coating and deposition to be avoided, thus preventing undesired reactions, e.g. decomposition reactions between the materials and components of the atmosphere such as oxygen, nitrogen, or CO₂.

In a further particularly preferred embodiment, the coating step is carried out immediately prior to the deposition, in particular in order to prevent a reaction of the coating and/or the further coating with atmospheric components. In particular, for example, a reaction of residual atmospheric components in a coating step, which preferably takes place in a vacuum atmosphere, can be prevented. The advantage in this case is that reactive or highly reactive materials can therefore be used as a coating, for example garnets, in particular LiₓLaZrO, sulfidic or phosphatic glasses, in particular Li₁₀XP₂S₁₂, where X=Ge, Sn, and/or argyrodite, in particular Li₆PS₅CI. Because coating of the material is carried out immediately prior to the deposition step, the coating does not react with atmospheric components, in particular residual atmospheric components remaining in the device, and therefore does not degrade, so that it is also possible to use reactive materials. Moreover, the likelihood of contamination of the materials is lower, and degradation of any possibly unstable material is prevented. In addition, the materials are not exposed to any long-term effects of harmful gases.

In a further advantageous embodiment, the method comprises an aerosol coating method (ADM, aerosol deposition method).

In the aerosol coating method, for example, a suitable powder is converted to an aerosol. By means of a rough vacuum produced in the coating chamber and the pressure difference resulting therefrom, the aerosol is accelerated in a nozzle to several 100 m/s and then deposited on a substrate. In this process, in addition to plastic deformation, the powder particles also break for example into fragments, which are then arranged e.g. into a dense and favorably adhering layer.

In this case, it is advantageous that the coating method is preferably a cold coating method. Neither the substrate nor the material particles or the coating of the material particles are heated by a heat input from outside. Because of the impact solidification at room temperature, no sintering or tempering steps are needed in order to form a layer.

In an alternative embodiment, the method comprises a plasma spraying process.

For example, the step of coating the material particles with a coating comprises sputtering or vapor deposition, or an ALD/CVD (atomic layer deposition/chemical vapor deposition) coating process. In the use of sulfidic glasses as a coating, for example, favorable conducting networks are formed simply by contact of the particles among one another.

Moreover, a battery cell, in particular a solid-state battery cell, is also the subject matter of the invention, wherein a plurality of layers of the battery cell are configured such that a first coating of material particles of the respective layer bonds to the first coating of further material particles of the respective layer, wherein a layer of the battery cell in particular corresponds to an anode conductor layer, an anode-active material layer, an electrolyte layer, a cathode conductor layer, a cathode-active material layer and/or a protective layer composed of a protective material. The advantage in this case is that in this way, it is possible to produce the layers of the battery cell quickly and in a time-saving manner, as the layers can be produced in the same facility using the same methods.

An additional embodiment is based on a configuration in which at least one layer of the battery cell has a gradient, in particular an anode- and/or cathode-active material layer, wherein for example an ion conductor portion of the anode- and/or cathode-active material layer varies over the thickness of the anode- and/or cathode-active material layer. In this manner, the diffusion differences of the ions are at least largely compensated for. The ion density at various depths of the respective layer can therefore be taken into account and compensated for. This obviates the need for time- and cost-intensive forming steps.

Moreover, a device for producing the battery cell is also the subject matter of the present invention, wherein the device comprises a coating chamber for the coating of material particles, a deposition chamber for the deposition of material particles with a coating, and a plurality of nozzles, in particular one or a plurality of slot nozzles and/or air blades that are installed in parallel or in series with respect to one another. The advantage of this configuration is that the device can be designed in a highly flexible manner, and parameters such as the thickness of the layer, the density of the layer, and the lateral dimensions of the layer can be adjusted extremely rapidly. Furthermore, the device is rapidly and easily scalable on large substrate surfaces. A further advantage is that rapid and simple tests can be conducted on various compositions, composite structures of coatings, and/or particles. By means of the device, the production of complex and highly complex composite materials with combined properties, for example material particles with two or more coatings and/or coatings composed of mixtures of different materials, is also possible. In this case, the different coatings and/or the coatings composed of material mixtures are either deposited with the same nozzle or with a plurality of nozzles focussed on the same point.

Particularly preferably, the method and the device for producing a battery cell, in particular a solid-state battery cell, are a method and a device for producing a lithium-ion battery cell.

Particularly preferably, the battery cell, in particular the solid-state battery cell, is a lithium-ion battery cell, which is used for example in electrical or hybrid vehicles.

### BRIEF DESCRIPTION OF THE DRAWINGS

Embodiments of the present invention are shown in the drawings and explained in further detail in the following description of the figures, which show the following:

FIG. 1: A schematic cross-sectional view of a device for producing a battery cell according to the invention with a coating chamber, a deposition chamber, and a plurality of nozzles,

FIG. 2a: A schematic cross-sectional view of a material particle having a first coating before a deposition step of the method according to the invention in a first embodiment,

FIG. 2b: A schematic cross-sectional view of material particles having a first coating according to FIG. 2a after the deposition step of the method according to the invention in the first embodiment,

FIG. 3a: A schematic cross-sectional view of a material particle with a first and a second coating before a deposition step of the method according to the invention in a second embodiment,

FIG. 3b: A schematic cross-sectional view of material particles with a first and a second coating according to FIG. 3a after the deposition step of the method according to the invention in a first variant of the second embodiment,

FIG. 3c: A schematic three-dimensional view of the material particles with a first and a second coating according to FIG. 3b,

FIG. 3d: A schematic cross-sectional view of material particles with a first and a second coating according to FIG. 3a after the deposition step of the method according to the invention in the second variant of the second embodiment,

FIG. 4a: A schematic cross-sectional view of a material particle with a first and a second coating before a deposition step of the method according to the invention in a third variant of the second embodiment,

FIG. 4b: A schematic cross-sectional view of material particles with a first and a second coating according to FIG. 4a after a deposition step of the method according to the invention in a third variant of the second embodiment,

FIG. 5a: A schematic cross-sectional view of a battery cell according to the invention with a plurality of layers in a first embodiment, and

FIG. 5b: A schematic cross-sectional view of the battery cell of the present invention according to FIG. 3a in a second embodiment.

### DETAILED DESCRIPTION

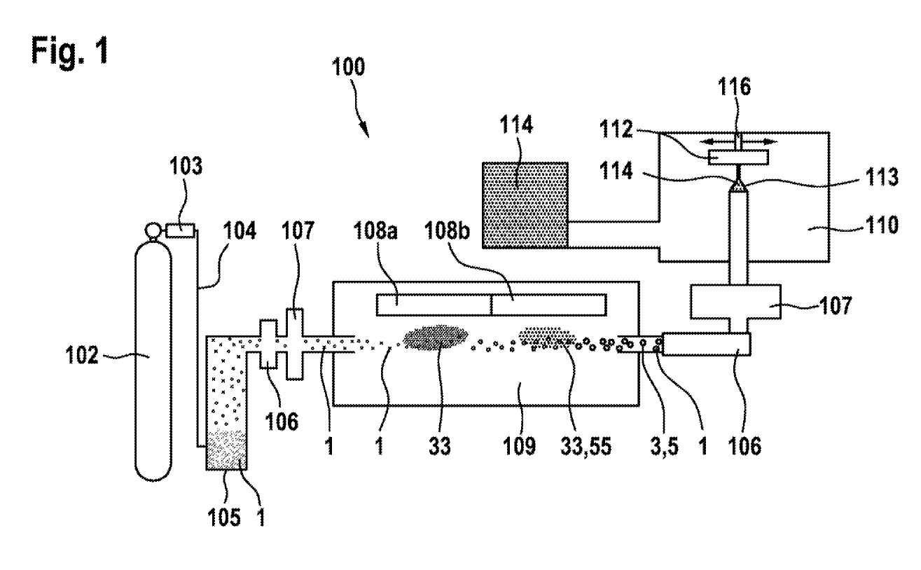

FIG. 1 shows a device 100 for producing a battery cell, in particular a lithium-ion battery cell. Beginning from a gas storage unit 102, a gas flow 104, for example, is regulated by means of a flow controller 103 and fed into a material particle reservoir 105 in which material particles 1 are present, for example in powder form. The material particles 1, for example, are active material particles of an electrode of a battery cell, or conducting material particles of an electrode of a battery cell. In an embodiment, the powder composed of material particles 1 is synthesized in a system installed upstream of the device 100, which is not shown, for example from the gas phase, e.g. by condensation of gas phase components. The material particles 1 are transported by the gas flow 104, for example filtered through a filter 106 and e.g. classified by means of a classifier 107, for example according to size, shape, or charge characteristics. The material particles 1 are then transported by the gas flow 104 into a coating chamber 109. In the coating chamber 109, for example, a first nozzle 108a and a second nozzle 108b are arranged, and the material particles 1 flow by these nozzles. By means of the first nozzles 108a, a first coating 3, for example, is applied to the material particles 1. FIG. 1 shows a first substance 33 sprayed by the first nozzle 108a for forming the first coating 3. By means of the second nozzle 108b, for example, a second coating 5 is applied to the first coating 3 of the material particles 1. FIG. 1 shows a second substance 55 sprayed by the second nozzle 108b for forming the second coating 5. Alternatively, a second coating 5 is applied to the first coating 3 of the material particles 1, said coating corresponding to the first coating 3, so that the latter is made thicker. In an alternative embodiment, only a first coating 3 is applied to the material particles 1 by a first nozzle 108a. In a further alternative embodiment, the coating chamber 109 comprises multiple nozzles (108a, 108b) so that a plurality of the same or different coatings 3, 5 is applied to the material particles 1. For example, the coating chamber 109 is configured as a vacuum coating chamber in which the coating(s) 3, 5 is/are applied under a vacuum to the material particles 1. Alternatively, the coating chamber 109, for example, is a sputtering chamber in which the coating(s) 3, 5 is/are sputtered onto the material particles 1. Further alternatively, the coating chamber 109 is for example a vapor deposition chamber in which the coating(s) 3, 5 is/are vapor-deposited on the material particles 1. Further alternatively, the coating chamber 109 is for example an ALD/CVD chamber in which the coating(s) 3, 5 is/are applied to the material particles 1 by means of an ALD/CVD process. The nozzles 108a, 108b are for example slot nozzles and/or air blades, which for example are installed in parallel or in series with respect to one another so that a plurality of coatings 3, 5 can be applied simultaneously or successively. A first or second coating 3, 5 can thus for example also comprise two or more different materials if the nozzles installed in parallel to each other 108a, 108b simultaneously coat the material particles 1. For example, the coating 3, 5 is configured as an open coating that does not completely surround the material particles 1 and is applied, for example, by means of a vapor deposition process. Alternatively, for example, the coating 3, 5 is a closed coating, which completely surrounds the material particles 1 and is applied to the material particles 1, for example, by means of an ALD/CVD method. The gas flow 104 is fed through the coating chamber 109 one or multiple times. Alternatively, the device 100 comprises a plurality of coating chambers 109 though which the gas flow 104 is fed one or multiple times. In this manner, for example, thicker coatings 3, 5 and/or a plurality of different coatings 3, 5 can be obtained. In a further step, the material particles 1 having a coating 3, 5 are for example filtered through a filter 106 and classified by means of a classifier 107. The gas flow 104 with the material particles 1 having a coating 3, 5 is supplied to a deposition chamber 110, in which the coated material particles 1 are deposited on a substrate 112 in a deposition step.

The substrate 112, for example, is an anode or cathode conductor layer of a battery cell or a ceramic layer, such as e.g. an electrolyte layer of a battery cell, in particular a solid-state electrolyte layer. Alternatively, the substrate 112 is an anode- or cathode-active material layer of a battery cell, a protective layer of a battery cell composed of a protective material, or a layer that is not a component of a battery cell, and for example only fulfills carrier functions. Alternatively, the substrate 112 is composed of multiple layers, for example various functional or carrier layers.

In order to deposit the coated material particles 1 on the substrate 112, for example, a vacuum is produced in the deposition chamber 110, for example by means of a pump 115. Because of the difference in pressure produced by the vacuum before and after the deposition nozzle 113, the coated material particles 1 are accelerated in the deposition nozzle 113 so that a material particle flow 114 is deposited on the substrate 112. Here, the position of the substrate 112 can be modified, for example by means of a movable frame 116. Deposition of the material particles is preferably carried out by means of an aerosol deposition method (ADM) or alternatively by means of a plasma spray method.

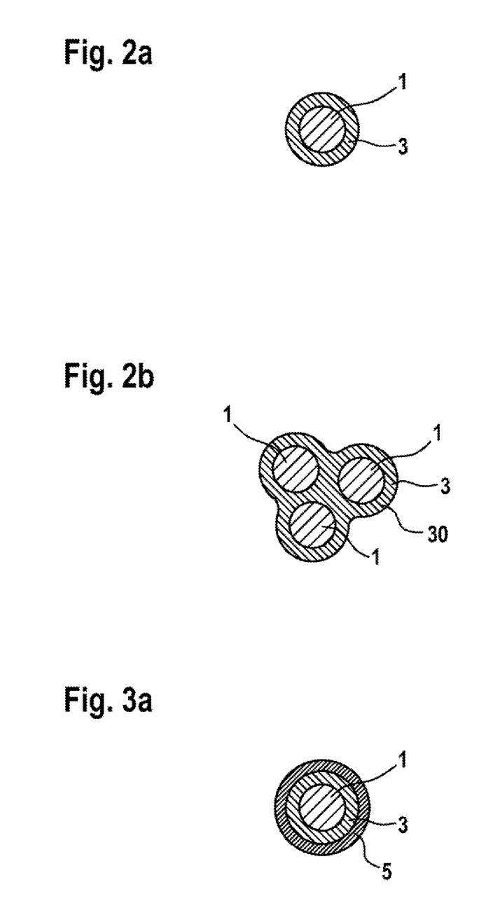

FIG. 2a shows an individual material particle 1 having a first coating 3 in a first embodiment before a step of deposition on a substrate 112. The first coating 3 is completely formed around the material particles 1.

FIG. 2b shows coated material particles 1 in the first embodiment according to FIG. 2a after the step of deposition on the substrate 112. In the deposition step, the material particles 1 having the first coating 3 are accelerated toward the substrate 112 in such a way that the first coating 3 of the material particles 1 bonds with the first coating 3 of further material particles 1 on impact on the substrate 112 so that a first layer 30 is formed. The first layer 30 is completely formed around the material particles 1. On impact of the coated material particles 1 on the substrate 112, the first coating 3, for example, breaks open and/or fuses with the coating 3 of further material particles 1, wherein in particular no heat is added from outside.

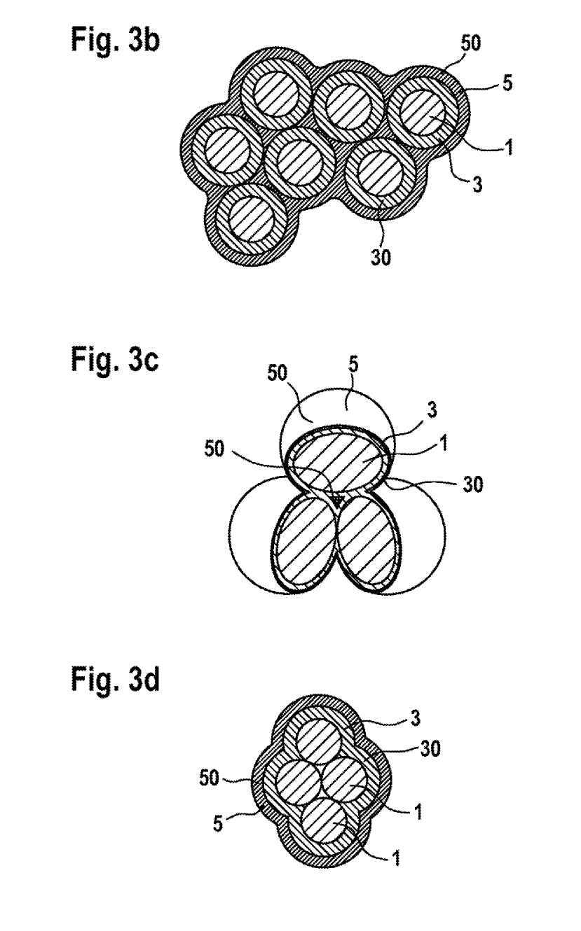

FIG. 3a shows an individual material particle 1 having a first coating 3 and a second coating 5 in a second embodiment prior to the step of deposition on the substrate 112. The first coating 3 is completely formed around the material particles 1, and the second coating 5 is completely formed around the first coating 3.

FIG. 3b shows coated material particles 1 according to FIG. 3a after the step of deposition on the substrate 112 in a first variant of the second embodiment. In the deposition step, the material particles 1 having the first coating 3 and the second coating 5 are accelerated toward the substrate 112 in such a way that the second coating 5 of the material particles 1 bonds with the second coating 5 of further material particles 1 on impact on the substrate 112, so that a second layer 50 is formed. In this case, the first coating 3 of the material particles 1 remains completely intact around the material particles 1 and bonds at least partially with the first coating 3 of further material particles 1 so that a first layer 30 is formed. On impact of the coated material particles 1 on the substrate 112, the second coating 5, for example, breaks open and/or fuses with the second coating 5 of further material particles 1, wherein in particular no heat is added from outside. In this case, the second layer 50 in particular surrounds the entirety of the material particles 1 with the first layer 30 so that the outermost layer is continuously formed by the second layer 50. On impact on the substrate 112, for example, the first coating 3 also at least partially breaks open and/or at least partially fuses with the first coating 3 of further material particles 1. In an alternative variant not shown in the figures, the first coating 3 does not break open and also does not fuse with the first coating 3 of further material particles 1, but in particular is completely surrounded by the second layer 50.

FIG. 3c shows the coated material particles 1 after the deposition step according to FIG. 3b in a three-dimensional view.

FIG. 3d shows coated material particles 1 according to FIG. 3a after the step of deposition on the substrate 112 in a second variant of the second embodiment. In the deposition step, the material particles 1 having the first coating 3 and the second coating 5 are accelerated toward the substrate 112 in such a way that the second coating 5 of the material particles 1 bonds with the second coating 5 of further material particles 1 on impact on the substrate 112 so that a second layer 50 is formed. In this case, the first coating 3 of the material particles 1 bonds with the first coating 3 of further material particles 1 so that a first layer 30 is formed. Here, the first layer 30 of the material particles 1 remains only partially intact around the material particles 1 so that the material particles 1 at least partially come into contact with one another. However, the first layer 30 surrounds the material particles 1, for example, in their entirety so that they do not come into contact with the second layer 50. On impact of the coated material particles 1 on the substrate 112, the second coating 5, for example, breaks open and/or fuses with the second coating 5 of further material particles 1, wherein in particular no heat is added from outside. In this case, for example, the first coating 3 also at least partially breaks open and/or at least partially fuses with the first coating 3 of further material particles 1.

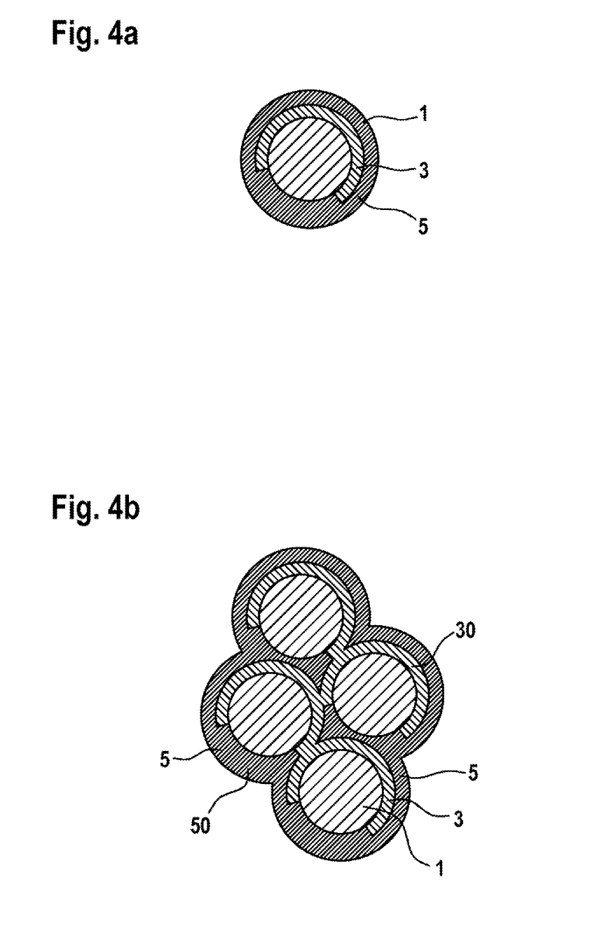

FIG. 4a shows an individual material particle 1 having a first coating 3 and a second coating 5 in a third variant of the second embodiment prior to the step of deposition on the substrate 112. The first coating 3 is only partially formed around the material particles 1. The second coating 5 is entirely formed around the material particles 1 with the partial first coating 3.

FIG. 4b shows coated material particles 1 according to FIG. 4a after the step of deposition on the substrate 112 in the third variant of the second embodiment. In the deposition step, the material particles 1 with the partial first coating 3 and the second coating 5 are accelerated toward the substrate 112 in such a way that the second coating 5 of the material particles 1 bonds with the second coating 5 of further material particles 1 on impact on the substrate 112 so that a second layer 50 is formed. Here, the partial first coating 3 of the material particles 1 bonds with the partial first coating 3 of further material particles 1 so that a first layer 30 is formed. In this case, the first layer 30 of the material particles 1 remains partially intact around the material particles 1. Here, the material particles 1 do not come into contact with one another. Moreover, they are partially surrounded by the first layer 30 and partially by the second layer 50. The second layer 50 preferably surrounds the material particles 1 and the first layer 30 in their entirety so that the outermost layer is formed by the second layer 50.

In an alternative embodiment not shown in the figures, the material particles 1 come at least partially into contact with one another.

On impact of the coated material particles 1 on the substrate 112, the second coating 5, for example, breaks open and/or fuses with the second coating 5 of further material particles 1, wherein in particular, no heat is added from outside. In this case, for example, the first coating 3 also at least partially breaks open and/or at least partially fuses with the first coating 3 of further material particles 1.

The following explanations pertain to all of the aforementioned embodiments and variants of FIGS. 2a through 4b and the explanations thereof.

On impact of the coated material particles 1 on the substrate 112, it is possible, for example, that the material particles 1 will undergo chemical reactions with the first coating 3 and/or that chemical or physical bonds will form. It is additionally or alternatively possible that the first coating 3 will undergo chemical reactions with a second coating 5 and/or that chemical or physical bonds will form. In embodiments with a plurality of coatings, this also applies to these coatings.

The material particles 1 are for example active material particles of an electrode of a battery cell, for example lithium metal oxides such as lithium cobalt dioxide (LiCoO₂) or lithium nickel cobalt manganese oxides, in particular LiNi_{1/3}Co_{1/3}Mn_{1/3}O₂, or a lithium iron phosphate (LiFePO₄) or conducting material particles of an electrode of a battery cell, for example carbon-containing material particles 1 such as soot, graphite, or graphene.

The first coating 3 and/or the second coating 5 is configured for example to be ion-conducting; in particular, the first coating 3 and/or the second coating 5 comprises a garnet, in particular LiLaZrO, a sulfidic or a phosphatic glass, in particular Li₁₀XP₂S₁₂, where X=Ge, Sn, and/or an argyrodite, in particular Li₆PS₅CI. Alternatively or additionally, the first coating 3 and/or the second coating 5 is configured to be electron-conducting, preferably by means of carbon-containing compounds such as soot, graphite, and graphene.

In an alternative or additional embodiment, the first coating 3 and/or the second coating 5 is an active material of an electrode of a battery cell, for example a lithium metal oxide, such as e.g. lithium cobalt dioxide (LiCoO₂) or lithium nickel cobalt manganese oxides, in particular LiNi_{1/3}Co_{1/3}Mn_{1/3}O₂, or a lithium iron phosphate (LiFePO₄). Alternatively, the first coating 3 and/or the second coating 5 is a protective material of a battery cell, for example an aluminum oxide (AI₂O₃), a zirconium oxide (ZrO₂), LiloSnP₂S₁₂, LiTi₂(PO₄)₃, a lithium niobate (LiNbO₃), a lithium phosphate (Li₃PO₄) or (LiSn₂(PO₄)₃).

In a particularly preferred embodiment, the material particles 1 comprise an active material of a battery cell, in particular a lithium nickel cobalt manganese oxide (LiNiₓCo_{y}Mn_{z}O₂) or a lithium nickel cobalt aluminum oxide (LiNiₓCo_{y}AI_{z}O₂). A first coating 3 is applied to the material particles 1, which in particular is configured to be ion-conducting. The ion-conducting first coating 3 comprises for example a garnet, in particular LiLaZrO, a sulfidic or a phosphatic glass, in particular Li₂SyP₂S₅, where x,y=Ge, Sn, and/or an argyrodite, in particular Li₆PS₅CI. A second coating 5, for example, is applied to the first coating 3, which for example contains carbon, and in particular comprises a soot, a graphite, or a graphene.

For example, a further coating or an alternative second coating 5 comprises on the one hand carbon-containing components, in particular soot, a graphite, or a graphene, and on the other elastic components, in particular a polyethylene oxide. Elastic components are used for example to absorb volume changes in the battery cell and alleviate them.

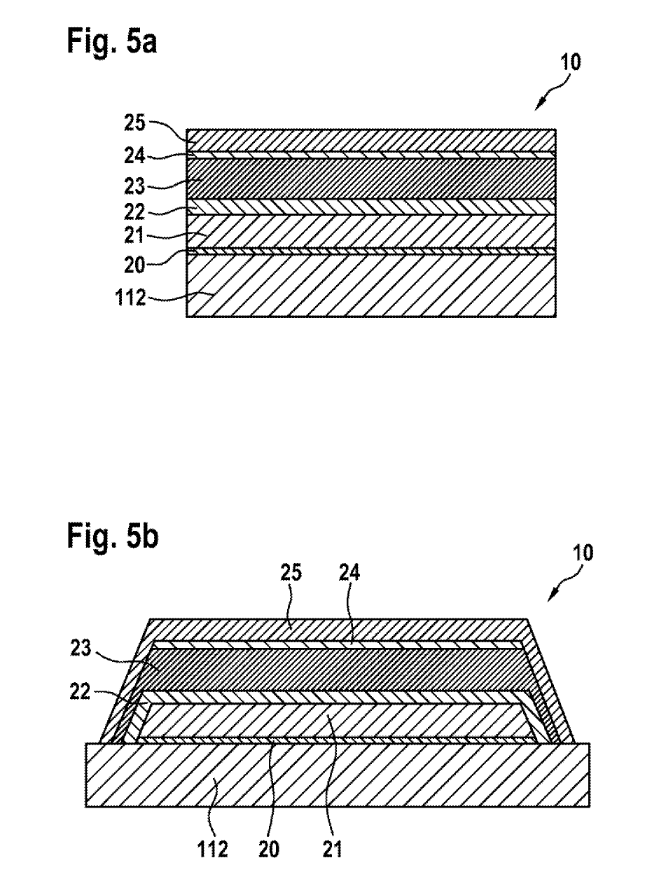

FIG. 5a shows a battery cell 10, in particular a solid-state battery cell, immediately after the step of deposition on the substrate 112. The battery cell 10 comprises a plurality of layers 20, 21, 22, 23, 24, 25 that are configured such that a first coating 3 of material particles 1 of the respective layer 20, 21, 22, 23, 24, 25 bonds with the first coating 3 of further material particles 1 of this respective layer 20, 21, 22, 23, 24, 25 as shown in FIGS. 2a-4b. These layers 20, 21, 22, 23, 24, 25 of the battery cell 10, for example, are an anode conductor layer 20, an anode-active material layer 21, and electrolyte layer 22 configured as a solid body that functions as a separator, among other functions, a cathode-active material layer 23, a cathode conductor layer 24, and/or a protective layer 25 composed of a protective material. The various layers 20, 21, 22, 23, 24, 25 are applied, for example, by means of a method that in particular comprises an aerosol coating method, such as e.g. shown in FIG. 1. In an embodiment, in this process, the anode conductor layer 20 is first deposited on the substrate 112 as shown in FIG. 5a. In an alternative embodiment, the cathode conductor layer 24 is first deposited on the substrate 112.

The anode conductor layer 20 comprises for example a copper, and the anode-active material layer 21 of the anode comprises for example lithium, a graphite, in particular a natural or a synthetic graphite, silicon, and/or a titanate. The electrolyte layer 22, which functions as a separator, among other functions, comprises for example a garnet and/or a sulfidic glass. The cathode-active material layer 23 of the cathode comprises for example a lithium metal oxide or a lithium metal phosphate, and the cathode conductor layer 24 comprises for example an aluminum or a nickel. The protective layer 25 composed of a protective material comprises for example a metal nitride or a metal oxide.

In an embodiment, at least one of the layers 20, 21, 22, 23, 24, 25 of the battery cell 10 comprises a gradient, in particular an anode-active material layer 21 and/or a cathode-active material layer 23, wherein an ion-conducting portion of the anode-active material layer 21 and/or the cathode-active material layer 23 varies over the thickness of the anode-active material layer 21 and/or the cathode-active material layer 23.

FIG. 5b shows the battery cell 10 according to FIG. 3a in a second embodiment. The electrolyte layer 22 also surrounds the anode-active material layer 21 laterally so that the anode-active material layer 21 is surrounded on all sides by the electrolyte layer 22 with the exception of the surface on which the anode-active material layer 21 is deposited on the substrate 112. Moreover, the cathode-active material layer 23 surrounds the electrolyte layer 22 on all sides with the exception of the surface on which the electrolyte layer 22 is deposited on the anode-active material layer 21 and the surface on which the electrolyte layer 22 lies on the substrate 112. The protective layer 25 surrounds the aforementioned layer stacks on all surfaces that are not adjacent to the substrate 112. In this manner, the layers lying under the protective layer 25 are protected.

1. A method for producing a battery cell (10), the method comprising providing, in a coating step, material particles (1) having a first coating (3), and, in a deposition step, accelerating the material particles (1) having the first coating (3) toward a substrate (112) in such a way that the first coating (3) of the material particles (1) bonds on impact on the substrate (112) with the first coating (3) of further material particles (1) so that a first layer (30) is formed.

2. The method as claimed in claim 1, characterized in that at least one second coating (5) is applied to the first coating (3) of the material particles (1).

3. The method as claimed in claim 2, characterized in that the first coating (3) of the material particles (1) and/or the second coating (5) breaks open on impact on the substrate (112) and/or fuses with the first coating (3) of further material particles (1) and/or the second coating (5).

4. The method as claimed in claim 2, characterized in that the first coating (3) and/or the second coating (5) is configured to be an ion-conducting coating and/or electron-conducting coating.

5. The method as claimed in claim 4, characterized in that the ion-conducting coating (3, 5) comprises a garnet, a sulfidic or phosphatic glass, and/or an argyrodite.

6. The method as claimed in claim 2, characterized in that the first coating (3) and/or the second coating (5) is/are an active material and/or the first coating (3) and/or the second coating (5) is/are a protective material.

7. The method as claimed in claim 1, characterized in that the material particles (1) are active material particles of an electrode of the battery cell (10) or conducting material particles of an electrode of the battery cell (10).

8. The method as claimed in claim 2, characterized in that the coating step, in which the material particles (1) having the first coating (3) and/or the second coating (5) are provided, and the deposition step take place in the same device (100).

9. The method as claimed in claim 2, characterized in that the coating step is conducted immediately prior to the deposition step.

10. The method as claimed in claim 1, characterized in that the method comprises an aerosol deposition method (ADM).

11. A battery cell (10) comprising a plurality of layers (20, 21, 22, 23, 24, 25) configured such that a first coating (3) of material particles (1) of the respective layer (20, 21, 22, 23, 24, 25) bonds with the first coating (3) of further material particles (1) of the respective layer (20, 21, 22, 23, 24, 25).

12. The battery cell (10) as claimed in claim 11, characterized in that at least one layer (20, 21, 22, 23, 24, 25) of the battery cell (10) comprises a gradient.

13. (canceled)

14. The method as claimed in claim 1 wherein the first layer (30) is formed without an input of heat from outside.

15. The method as claimed in claim 4, characterized in that the ion-conducting coating (3, 5) comprises LiLaZrO, Li₁₀XP₂S₁₂, where X=Ge, Sn, and/or Li₆PS₅CI.

16. The method as claimed in claim 2, characterized in that the coating step is conducted immediately prior to the deposition step in order to prevent reaction of the coating (3) and/or the second coating (5) with atmospheric components.

17. The battery cell (10) as claimed in claim 11, wherein the layers (20, 21, 22, 23, 24, 25) of the battery cell (10) are an anode conductor layer (20), an anode-active material layer (21) of an anode, an electrolyte layer (22), a cathode conductor layer (24), a cathode-active material layer (23) of a cathode, and/or a protective layer (25).

18. The battery cell (10) as claimed in claim 11, characterized in that at least one layer (20, 21, 22, 23, 24, 25) of the battery cell (10) comprises an anode-active material layer (21) and/or a cathode-active material layer (23), wherein an ion-conducting portion of the anode-active material layer (21) and/or the cathode-active material layer (23) varies over the thickness of the anode-active material layer (21) and/or the cathode-active material layer (23).
